(19) United States
(12) Patent Application Publication
(10) Pub. No.: US 2019/0159648 A1
(43) Pub. Date: May 30, 2019

(54) FUR SWEEPER TOOL AND METHODS

(71) Applicant: Spectrum Brands, Inc., Middleton, WI (US)

(72) Inventors: Adam M. Favia, Reedsburg, WI (US); Darrin J. Anderson, Mauston, WI (US); Ron W. Wright, Baraboo, WI (US)

(21) Appl. No.: 15/822,608

(22) Filed: Nov. 27, 2017

(51) Int. Cl. A47L 13/16; A47L 25/08; B08B 1/00; B08B 1/04; B25G 3/38

(52) U.S. Cl. CPC A47L 13/16; A47L 25/08; B25G 1/04; B08B 1/04; B25G 3/38; B08B 1/001

(57) ABSTRACT

A fur sweeper tool includes a base holder; a handle-engaging post extending from the base holder; a roller rotatably held by the base holder having fur attracting material; and a handle pivotably connected to the post. The handle may have an adjustable length.

### TECHNICAL FIELD

This disclosure concerns a tool that can be used for the collection of hair, particularly when grooming animals. In particular, this disclosure concerns a fur sweeper tool having an adjustable and pivotable handle relative to the tool head.

### BACKGROUND

For households that include animals as pets, the accumulation of fur or hair from the animals on furniture, carpeting, or clothing can create a nuisance.

In the past, tools such as rollers having adhesive or sticky material were used. One problem is that the adhesive quality can wear off, or once too much hair adheres to the adhesive, the roller is no longer effective.

Furthermore, in the past, hair collectors using rollers were confined to a single size. If the hair was on high places, such as drapes, or low places, such as on the carpet, this could create a burden for the user in that these places are difficult to reach with a roller having a short handle.

Improvements in tools for hair cleanup or collection are desirable.

### SUMMARY

A fur sweeper tool is provided that improves the prior art.

In general, a fur sweeper tool includes a base holder; a handle-engaging post extending from the base holder; a roller rotatably held by the base holder having fur attracting material; and a handle pivotably connected to the post.

Preferably, the handle has an adjustable length.

In one or more embodiments, the handle includes at least one internal nut and threaded insert arrangement constructed and arranged to allow releasably lockable length adjustment.

In some arrangements, the handle includes three internal nut and threaded insert arrangements for length adjustment.

Preferably, the roller has a longitudinal axis which the roller rotates about. The handle pivots about a pivot axis that is parallel to the longitudinal axis of the roller.

In example embodiments, the handle pivots through a range of −90° to +90° relative to the pivot axis.

In still other embodiments, the handle pivots through a range of −10° to 60° relative to the pivot axis. For example, a typical range is 0° to 50°.

In example arrangements, the post and handle include a geared tooth and slidable lock button arrangement to permit adjustably locking the a pivot angle of the handle relative to the base holder.

In example arrangements, the post and handle include a protrusion-receiver arrangement constructed and arranged to permit pivoting of the handle relative to the base holder. The protrusion-receiver arrangement may include a pair of oppositely projecting protrusions extending from the post and having a pair of opposite openings in the handle receiving the protrusions.

In one or more embodiments, the base holder includes an open tube, and the roller is held within the open tube.

The base holder may have an opening providing exposure to the fur attracting material of the roller.

Preferably, the roller defines a chamber to collect fur.

The chamber may be accessible through a movable door secured to the base holder.

In preferred embodiments, the door is transparent.

Preferably, the door is selectively lockable and unlockable to the base holder.

In example arrangements, the roller includes first and second twist knobs at opposite ends of the roller and extending outside of the base holder. The twist knobs allow rotation of the roller within the base holder.

Preferably, the roller is rotatable between a first position at 0° to a second position greater than 90°.

In preferred arrangements, the fur attracting material includes a non-adhesive fabric. In some examples, the fabric is a directional fabric, in which the grain of the fabric material lays in a particular direction for effectiveness.

In another aspect, a method of collecting fur is provided. The method includes a step of grasping a handle of a fur sweeper tool. The fur sweeper tool can have a base holder, a post extending from the base holder connected to the handle, and a roller rotatably held by the base holder with fur attracting material. The method includes a step of, while rubbing the fur attracting material of the roller over a surface to pick up hair from the surface, allowing the base holder to pivot relative to the handle.

The method can further include a step of adjusting a length of the handle and rotatably locking the length in place.

The method may further include a step of rotating the roller by rotating one or more twist knobs secured thereto to at least partially clean hair from the fur attracting material of the roller.

A variety of examples of desirable product features or methods are set forth, in part, in the description that follows, and in part, will be apparent from the description, or may be learned by practicing various aspects of the disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is a perspective view of an embodiment of a fur sweeper tool, constructed in accordance with principles of this disclosure;

FIG. 2 is another perspective view of the fur sweeper tool of FIG. 1, and showing the handle in an extended position;

FIG. 3 is a side view of the fur sweeper tool of FIG. 1;

FIG. 4 is a cross-sectional view of the fur sweeper tool of FIG. 1, the cross-section being taken along the line 4-4 of FIG. 3;

FIG. 5 is an enlarged cross-sectional view of a portion of the handle shown in FIG. 4;

FIG. 6 is a cross-sectional view of the fur sweeper tool of FIG. 1 and showing the handle in an extended position;

FIGS. 7A, 7B, and 7C are cross-sectional views of sections of the handle from FIG. 6;

FIG. 8 is an enlarged cross-sectional view of a portion of the head of the tool of FIG. 4;

FIG. 9 is an exploded, perspective view of the head of a fur sweeper tool similar to what is shown in FIG. 1;

FIG. 10 is a side view of the fur sweeper tool of FIG. 1 and showing the handle pivoted through a range of motion relative to the tool head;

FIG. 11 is an enlarged perspective view of a portion of the fur sweeper tool of FIG. 1 and showing the pivotable connection between the handle and a post of the tool head;

FIG. 12 is an exploded, perspective view of the fur sweeper tool of FIG. 1 showing the handle exploded from the tool head;

FIG. 13 is a top view of the assembly of FIG. 12;

FIG. 14 is a top, cross-sectional view of the connection between the tool head and the handle as shown in FIG. 11;

FIG. 15 is a perspective view of another embodiment of a fur sweeper tool, the elongated handle being omitted from this drawings, for purposes of clarity;

FIG. 16 is an exploded, perspective view of the fur sweeper tool shown in FIG. 15;

FIG. 17 is a top view of the fur sweeper tool of FIG. 15, but showing a section of the handle pivoted relative to the head;

FIG. 18 is a cross-sectional view of the head and partial handle of FIG. 17, the cross section being taken along the line 18-18 of FIG. 17;

FIG. 19 is an enlarged, cross-sectional view of an adjustable locking arrangement between the head and handle utilized in the embodiment of FIGS. 15-18; and

FIG. 20 is another cross-sectional view of the adjustable locking arrangement of FIG. 19.

### DETAILED DESCRIPTION

A fur sweeper tool is shown in the FIGS. at 20. The fur sweeper tool 20 can be used to collect fur or loose hair from furniture, carpeting, or clothing. The tool 20 picks up the hair and collects it within a collection chamber. The collection chamber can be emptied, when needed.

The tool 20 includes a tool head 22 and a handle 24 secured to the head 22. The handle 24 is movably adjustable relative to the head 22, as described further below.

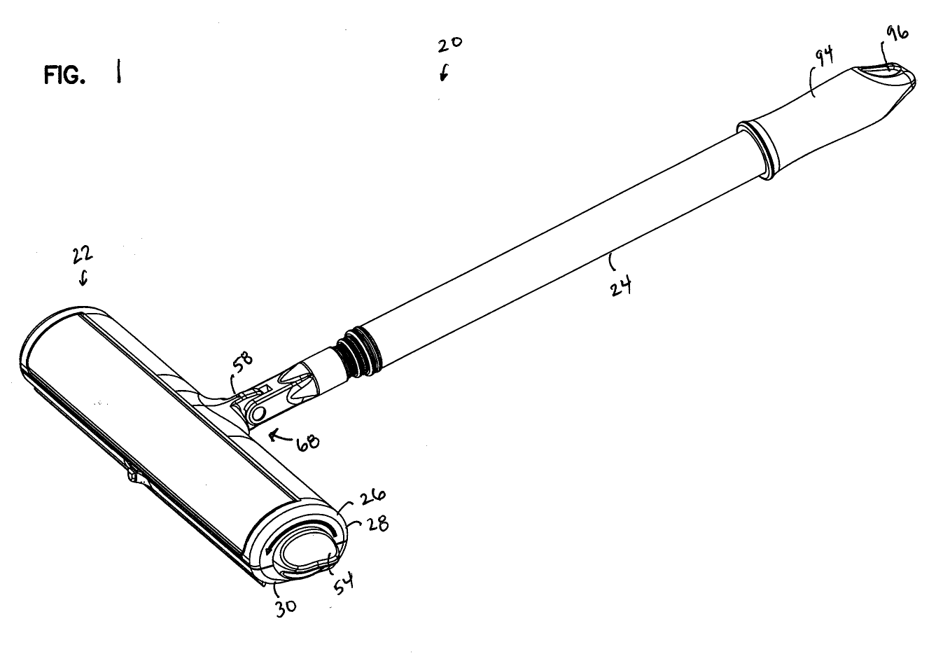

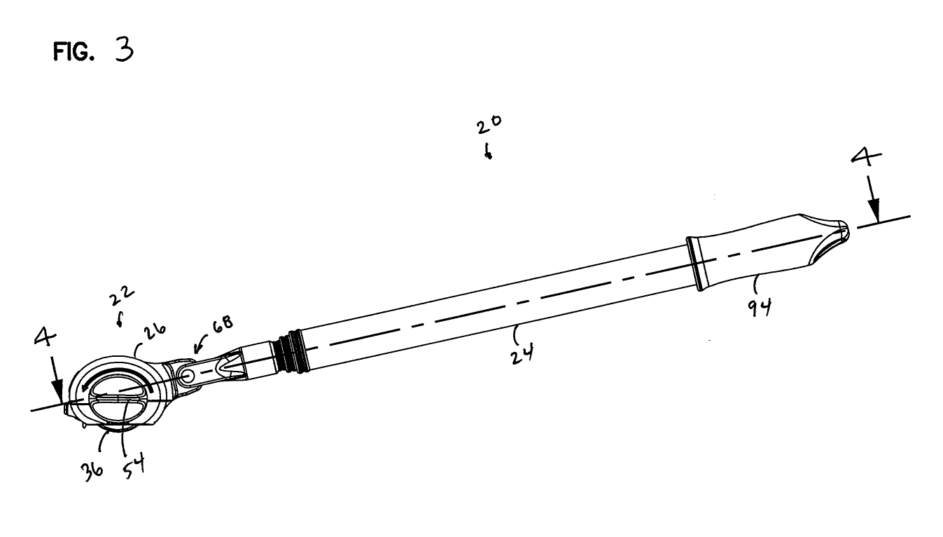

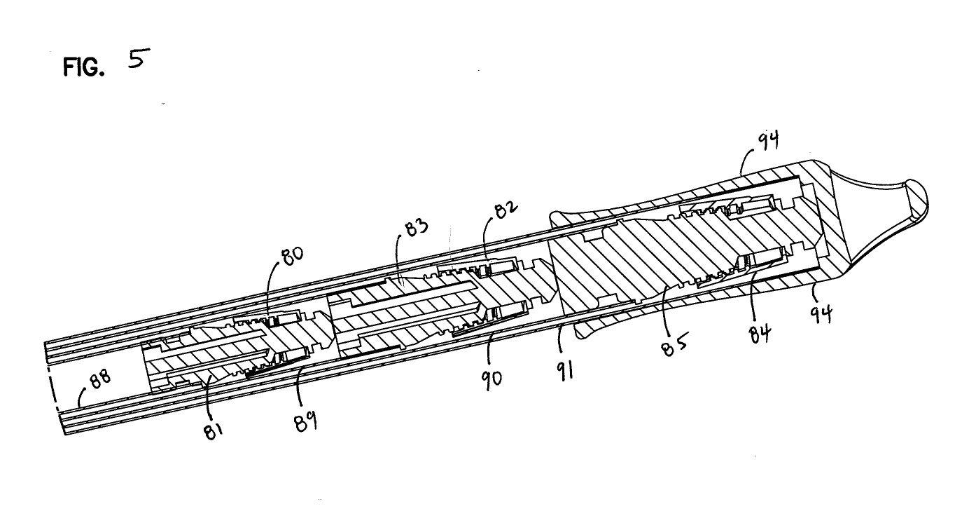

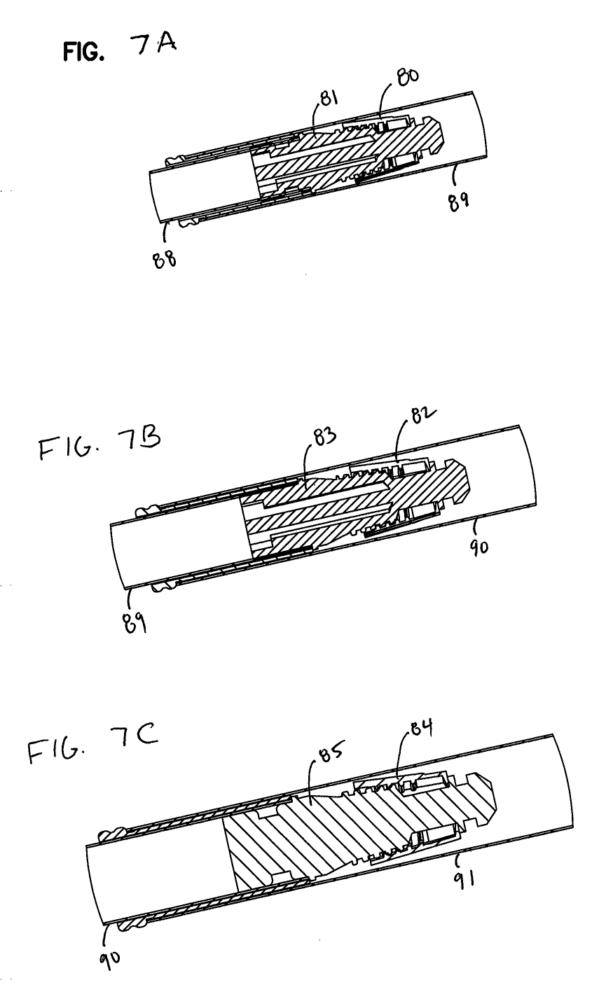

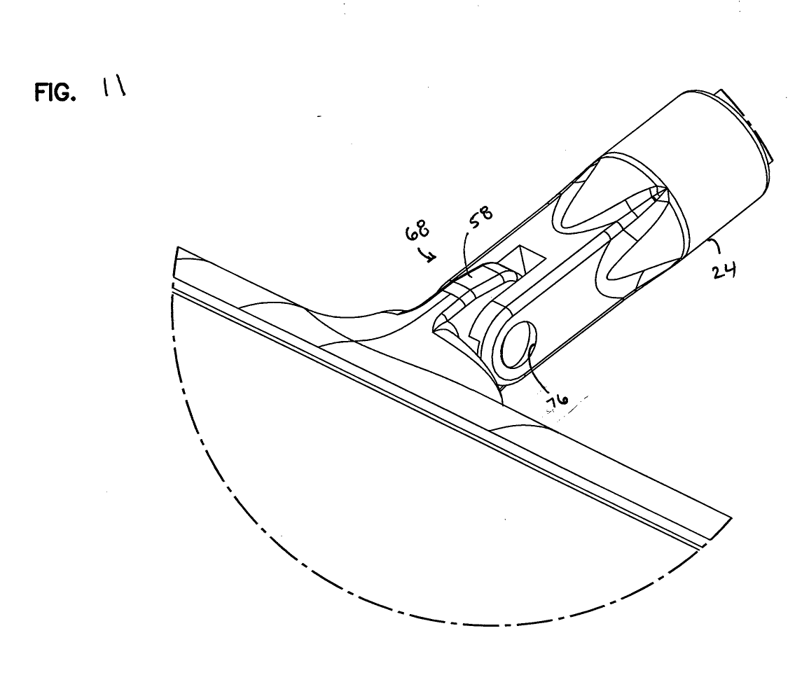

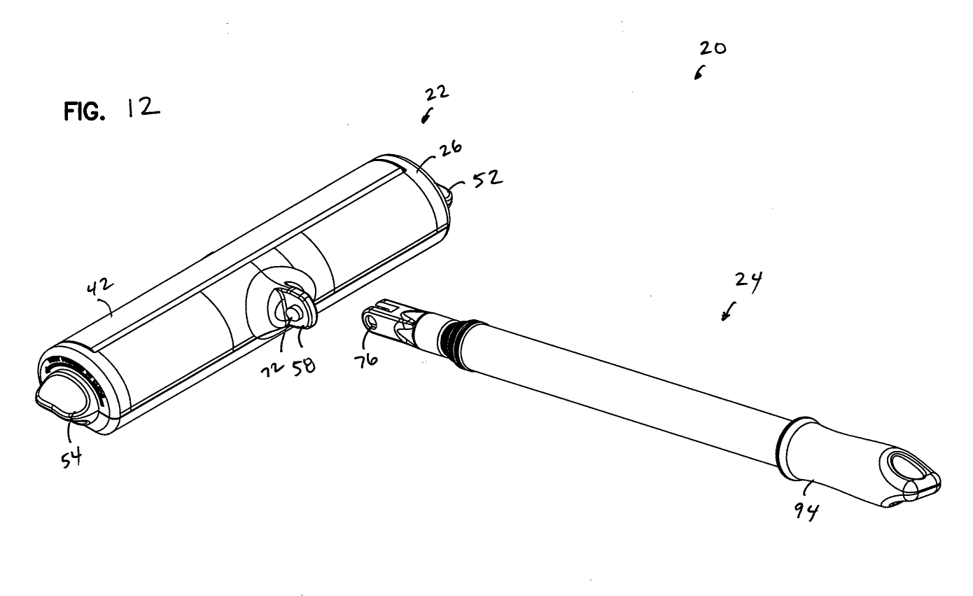

The Embodiment of FIGS. 1-14

A first embodiment of the fur sweeper tool 20 is shown in FIGS. 1-14, and described below.

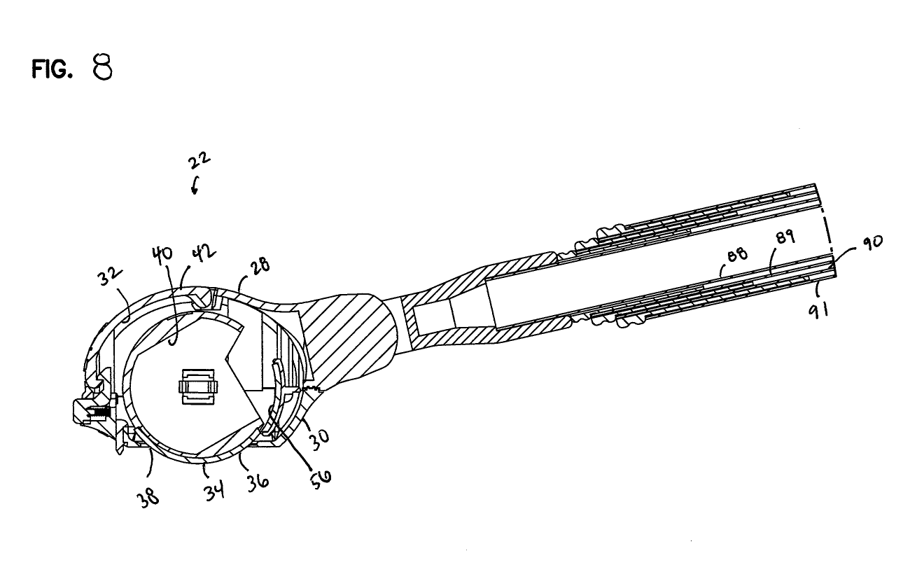

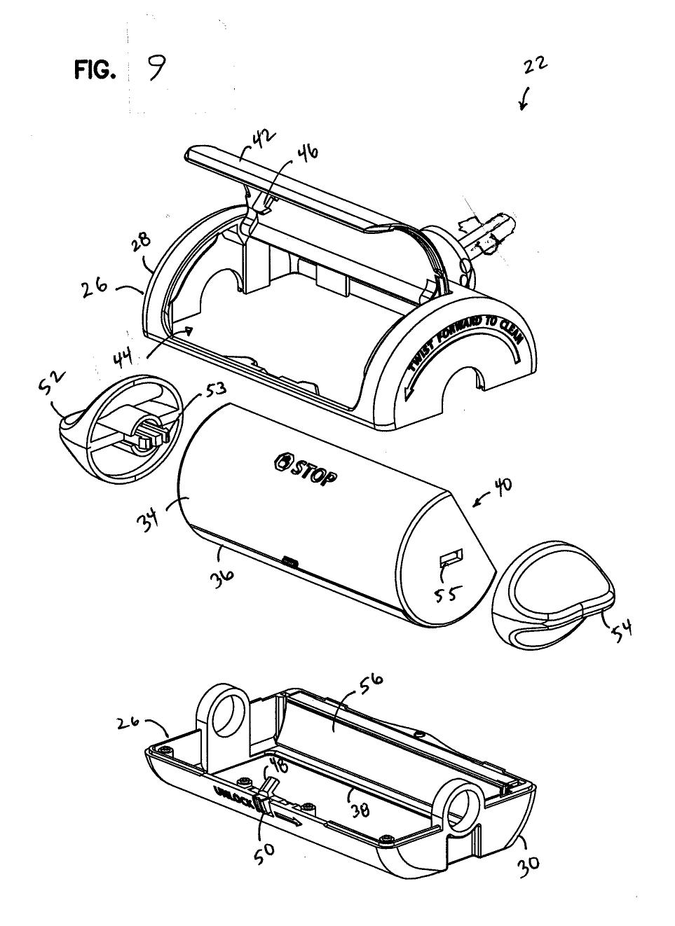

The head 22 includes a base holder 26. While many embodiments are possible, in one example embodiment, as shown in FIG. 9, the base holder 26 can include a first holder 28 and a second holder 30. The first and second holders 28, 30 are connectable together to define an open tube 32 (FIG. 8).

The head 22 further includes a roller 34 (FIGS. 8 and 9). The roller 34 is held by the base holder 26 and includes fur attracting material 36 (FIG. 8).

Many different embodiments are possible for the fur attracting material 36. In general, the fur attracting material 36 is a non-adhesive (non-sticky, non-tacky) fabric. The orientation of the material in the fabric is useful for attracting hair or fur. The fabric is preferably a directional fabric made of a polyester filament. While many variations are possible, in one example, the non-adhesive fabric is a thickness of about 1.8 mm having a surface resistance of 4.8×10⁹ ohms. The volume resistance can be about 8.7×10⁸ ohms.

In FIG. 9, it can be seen how the base holder 26 has or defines an opening 38 that provides exposure to the fur attracting material 36 of the roller 34. In this example, the second holder 30 defines the opening 38.

The roller 34 defines a chamber 40 (FIG. 8). The chamber 40 collects and stores fur that is picked up by the fur attracting material 36. The chamber 40 is accessible through a movable door 42. The door 42 is pivotably secured to the base holder 26. In FIG. 9, it can be appreciated that the door 42 is pivotably mounted to the first holder 28. When the door 42 is pivoted away from the base holder 26, an access opening 44 (FIG. 9) is exposed or opened. This will provide access to the chamber 40, when the roller 34 is rolled in a position to provide open communication between the access opening 44 and the chamber 40.

The door 42 is preferably transparent. When transparent, when the roller 34 is rotated so that the chamber 40 is in a position facing the door 42, the user can see how much fur is in the chamber 40.

The door 42 is selectively lockable and unlockable to the base holder 26. Many embodiments are possible. In the embodiment shown in FIGS. 8 and 9, the door 42 has a hook 46 and a slidable pin 48 (FIG. 9) that can be used to engage and disengage the hook 46. In the embodiment shown, the pin 48 is secured to the second holder 30. A tab 50 is visible from the exterior of the base holder 26, and the user can slide the tab 50 to move the pin 48 out of engagement 46, which will release the hook 46 and allow the door 42 to open. A spring may be used to have the door 42 pop open when the hook 46 is released.

The head 22 further includes first and second twist knobs 52, 54. The twist knobs 52, 54 are located at opposite ends of the roller 34 and extend outside of the base holder 26. The twist knobs 52, 54 are secured to the roller 34 such that rotating the twist knobs 52, 54 will rotate the roller 34 within the base holder 26. In FIG. 9, the twist knob 52 is visible with a connector 53 which is received in a corresponding receiver in the roller 34, an example being shown at 55 for the knob 54. It should be understood that the roller 34 includes receivers 55 for each knob 52, 54; and, each knob 52, 54 has a respective connector 53.

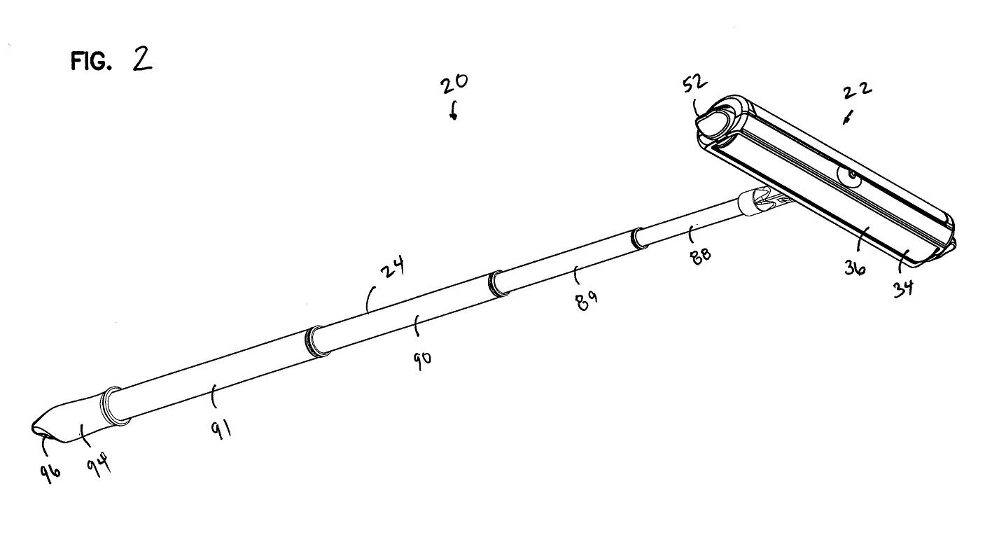

When the roller 34 is positioned for maximum exposure of the fur attracting material 34 relative to the opening 38, such as shown in FIG. 2, this is considered the working position or initial position. From this initial position, the roller 34 is rotatable in a range from this first position at 0° to a second position greater than 90°. The second position can be 180°, or it can be between 100° and 140° at a second position of maximum rotation relative to the first or initial position.

The base holder 26 includes a mechanism to allow for stripping of some of the fur or hair collected on the fur attracting material 36 to be removed from the roller 34 and deposited into the chamber 40. In this embodiment, the base holder 26 includes a section or strip of fur attracting material 56 (FIGS. 8 and 9). The section 56 of fur attracting material is mounted such that when the roller 34 is rotated relative to the base holder 26, the fur attracting material 36 on the roller 34 rubs against the section 56 of fur attracting material on the base holder 26. This interaction between fur attracting material 36 on the roller 34 and fur attracting material on the section 56 of the base holder 26 will help to strip off or remove at least some of the hair or fur on the roller 34 and push it into the chamber 40. In FIG. 9, the section 56 of fur attracting material is mounted to and held by the second holder 30 adjacent to the opening 44.

The tool 20 includes features to allow for adjustment of the handle 24 relative to the head 22. The tool 20 includes a handle-engaging post 56 extending from the base holder 26.

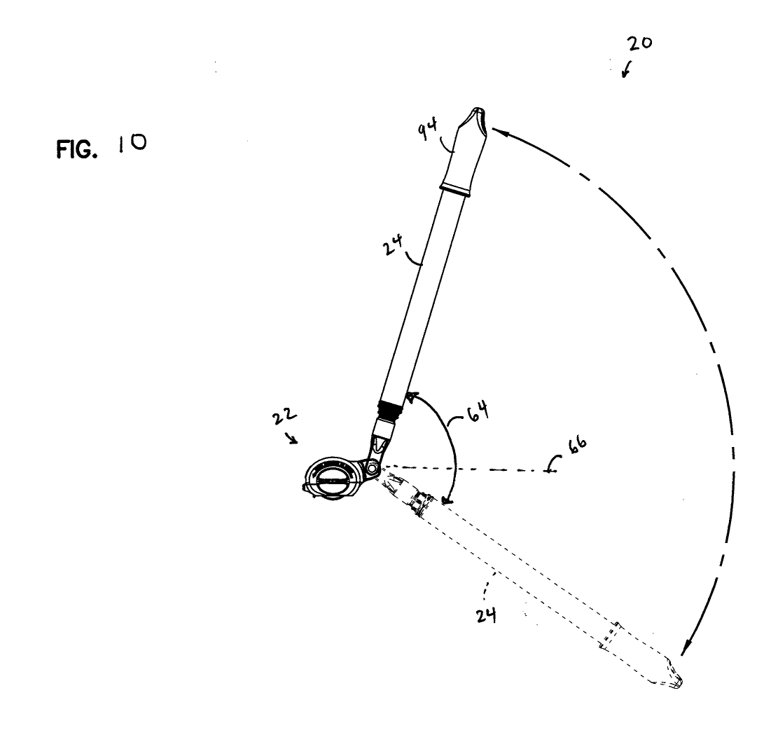

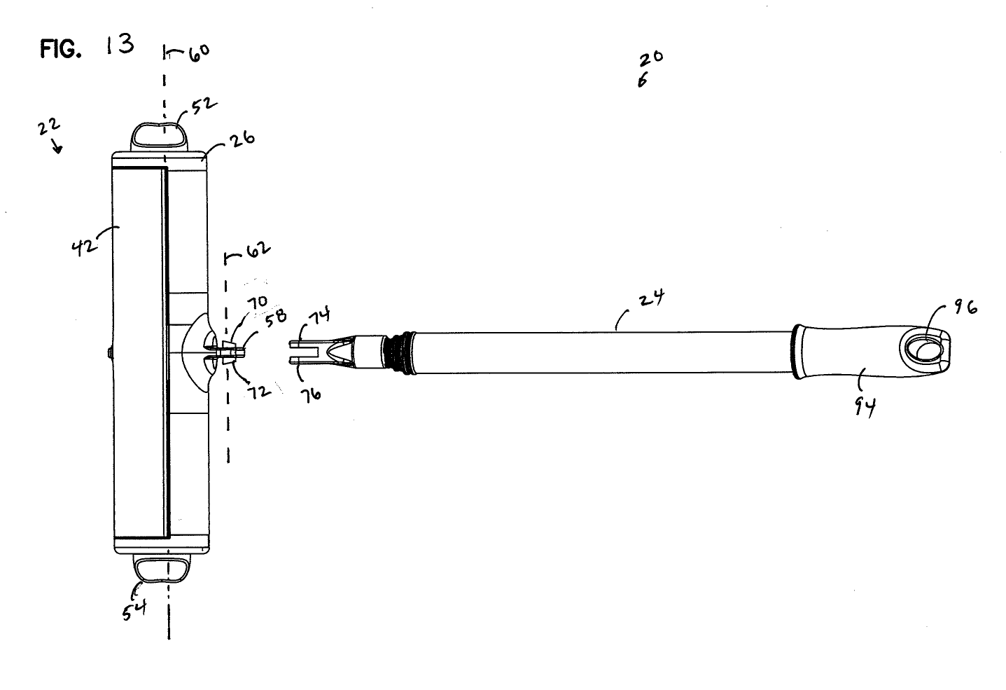

As mentioned above, the roller 34 is rotatable relative to the base holder 26. The roller 34 has a longitudinal axis 60 (FIG. 13) which the roller 34 rotates about. The handle 24 is constructed and arranged to pivot about a pivot axis 62 parallel to the longitudinal axis 60 of the roller 34. In FIG. 10, it can be seen how the handle 24 can pivot through a range relative to the pivot axis 62. The range is shown at angle 64 in FIG. 10 and can be in a range from −90° up to +90°, when measured from a neutral position, 66 when a longitudinal axis of the handle 24 is perpendicular to the longitudinal axis 60 of the roller 34. The angle 64 can also be within a smaller range of about −70° to +70°, relative to the neutral position 66.

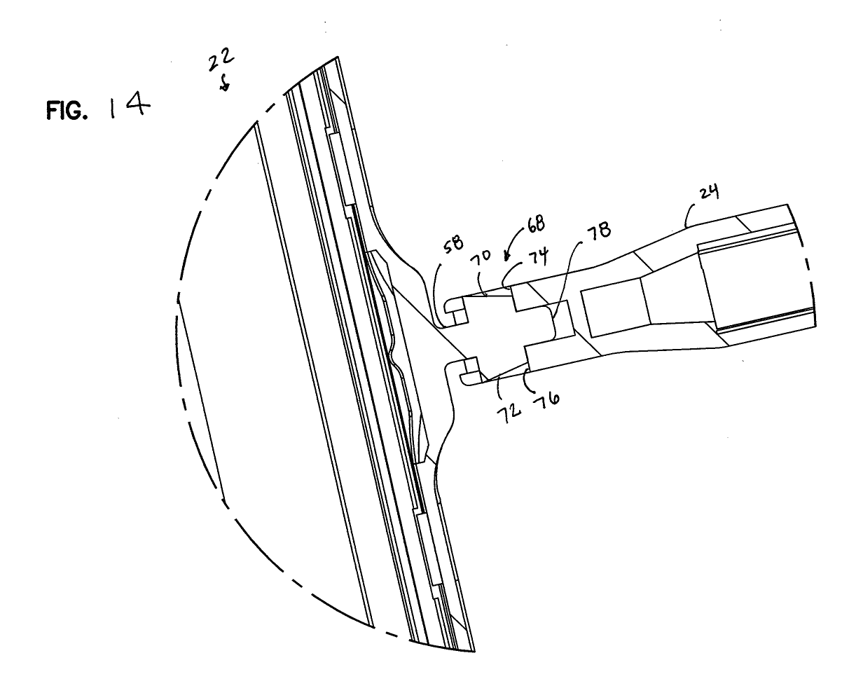

The handle 24 can be pivotable relative to the post 58 through a variety of mechanisms. An example shown, the handle 24 and post 58 include a protrusion-receiver arrangement 68 constructed and arranged to permit pivoting of the handle 24 relative to the base holder 26. In the embodiment shown, a pair of oppositely projection protrusions 70, 72 (FIGS. 13 and 14) extend from the post 58. A pair of opposite openings 74, 76 in the handle 24 receive the protrusions 70, 72. In other arrangements, the protrusions 70, 72 could be on the handle 24 while the openings could be on the post 58.

Referring now to FIG. 14, the protrusions 70, 72 are shaped to be slanted in a direction from narrowest width at the free end 78 of the post 58 increasing in height or width as the protrusions 70, 72 get closer to the base holder 26. This allows for easy assembly of the head 22 to the handle 24 by snapping the protrusions 70, 72 into the openings 74, 76 by leading with the narrower edges of the protrusions 72, 74. The wider edges of the protrusions 72, 74 catch in the openings 74, 76 of the handle 24.

This engagement by the protrusion-receiver arrangement 68 also allows for the pivoting or rotation of the handle 24 relative to the head 22 through the range shown at angle 64 in FIG. 10.

In accordance with principles of this disclosure, the handle 24 has an adjustable length. By comparing FIGS. 1 and 2, it can be seen how the handle 24 can be changed from a first position (FIG. 1) to an extended position (FIG. 2). The handle 24 may also be locked into positions between those shown in FIGS. 1 and 2.

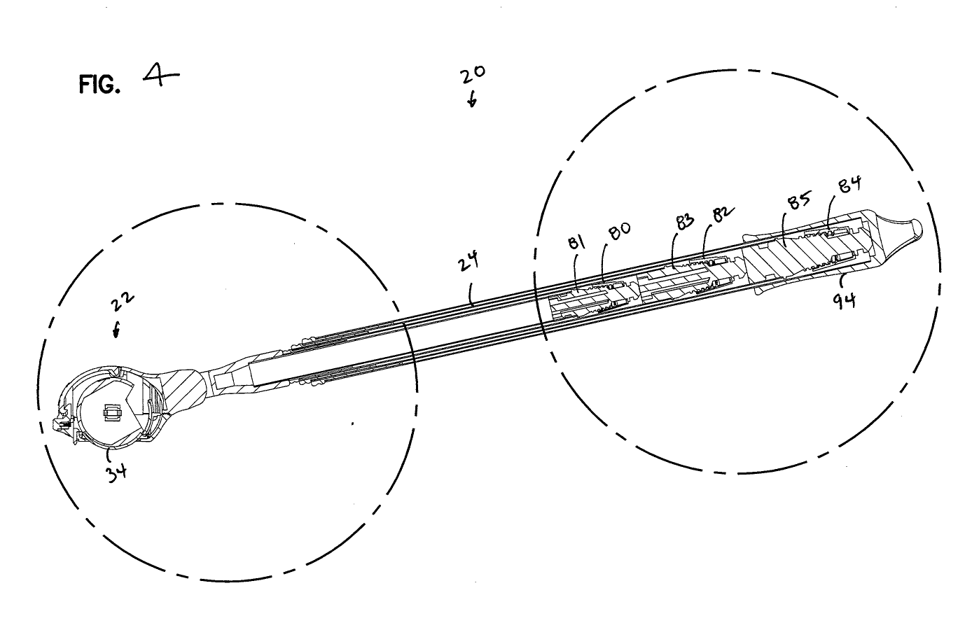

Many embodiments are possible for how to implement a length adjustment to the handle 24. In this embodiment, the handle 24 includes at least 1, and preferably three, internal nuts 80, 82, 84 (FIGS. 4-7). The nuts 80, 82, 84 rotatably engage a respectively positioned threaded insert 81, 83, 85.

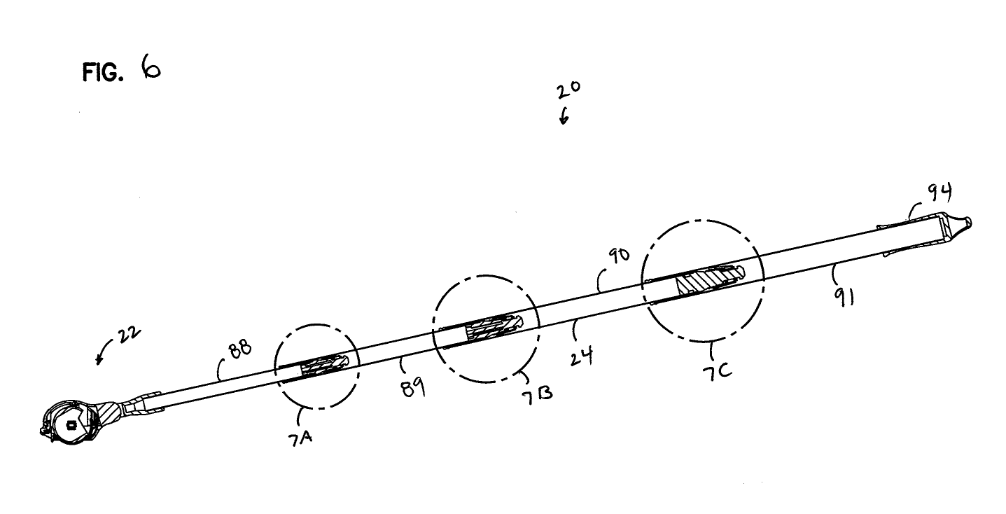

In the embodiment shown, the handle 24 includes a plurality of handle sections, shown in FIGS. 2 and 6 as four handle sections 88, 89, 90, 91. The section 88 is the one that is closest to the head 22 and at its head-engaging end, includes the portion of the protrusion-receiving arrangement 68 for pivotable engagement with the post 58.

The section 91 is at an opposite end of the handle 24 from the head 22. At its free end is a cover 94. The cover 94 may include an opening 96 to allow for handing the tool 20 from a hook.

The sections 88, 89, 90, and 91 can be slid in a telescoping fashion relative to each other. When the desired length is reached between different ones of the sections 88-91, the length can be locked in to place by rotating one of the nuts 80, 82, 84 into the respective insert 81, 83, 85 which will cause the nut to form an interference fit in the inside of the respective section 89, 90, 91. To release the handle 24 from the selected length, this operation may be reversed by unthreading the nuts 80, 82, 84 relative to the respective insert 81, 83, 85, which allows the sections 88-91 to adjust telescopically relative to each other.

In use, the fur sweeper tool 20 can be used to collect fur by rubbing the fur attracting material 36 on the roller 34 over a surface to pick up hair or fur from the surface. The method includes while rubbing the fur attracting material 36 of the roller 34 over a surface to pick up hair from the surface, allowing the base holder 26 to pivot relative to the handle 24.

The method can also include adjusting the length of the handle 24 and then rotatably locking the length of the handle 24 in place.

The method can further include a step of rotating the roller 34 by rotating one or more of the twist knobs 52, 54 to at least partially clean the hair from the fur attracting material 36. For example, this step can include moving the fur attracting material 36 against and relative to the section 56 of the fur attracting material, which will remove at least some of the fur from the fur attracting material 36 and push the fur into the chamber 40.

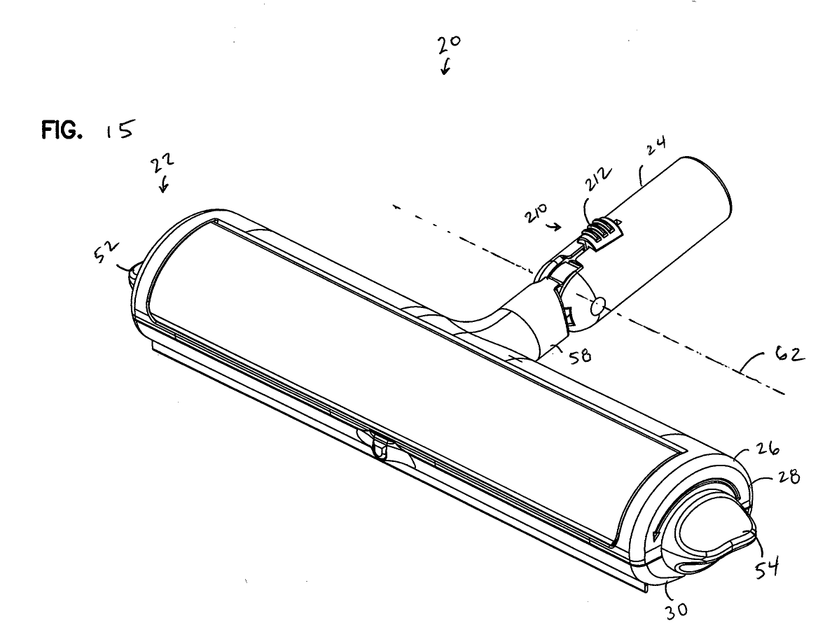

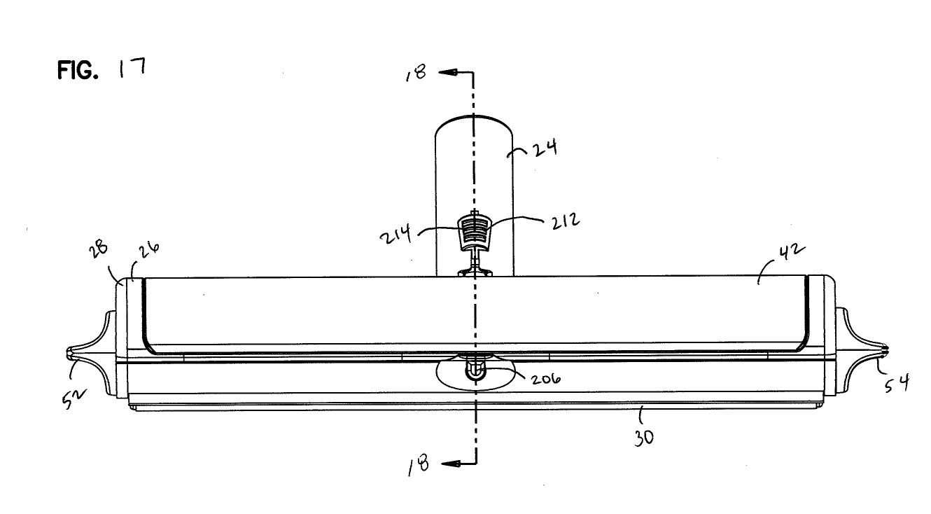

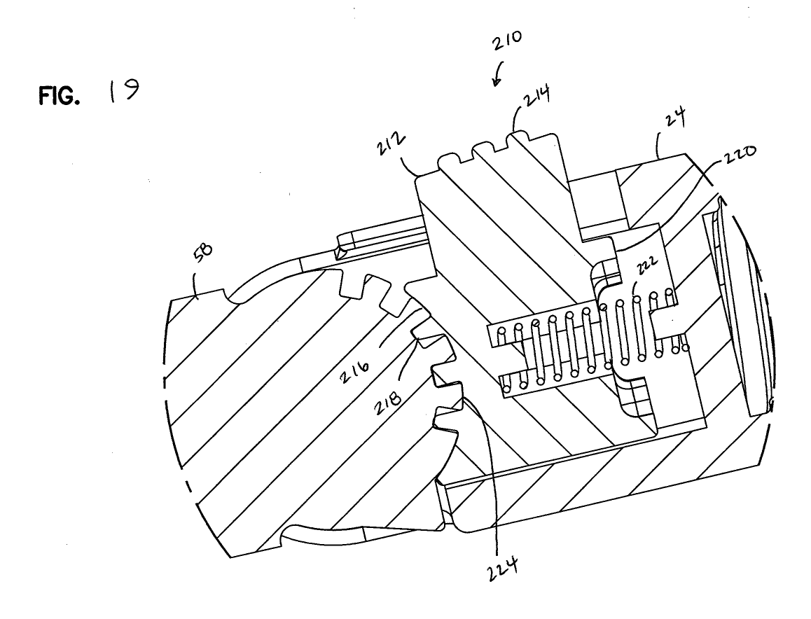

Another embodiment of the fur sweeper tool 20 is depicted in FIGS. 15-20. There are many similarities with the embodiment of FIGS. 1-14, and where common parts are used, the same reference numeral is used. Where the same reference numeral is used, there will not be repeated another description of that part. Rather, the description of that part with respect to the embodiment of FIGS. 15-20 is incorporated herein by reference. This description below will focus mainly on the differences between the embodiment of FIGS. 15-20 compared to the embodiment of FIGS. 1-14.

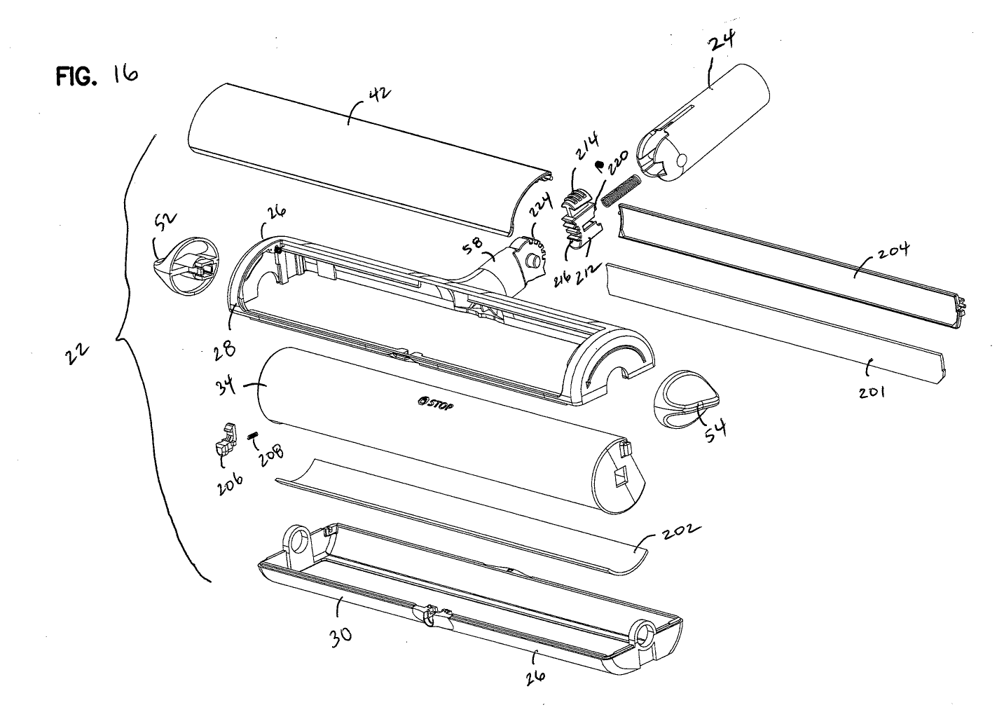

Attention is directed to FIGS. 15 and 16. The head 22, in this embodiment, includes two sections of fur attracting material 201, 202. The fur attracting material 201, 202 is preferably in the form of directional fabric, as described previously with respect to material 36. The fabric is a directional fabric, in which the grain of the fabric material lays in a particular direction for effectiveness. The section of fur attracting material 201 is adjacent to a kickoff plate 204. The kickoff plate 204 is located to allow for frictional engagement between the section 201 and the plate 204 in order to strip the hair or fur and allow it to be deposited within the collection chamber 40. The section 202 of fur attracting material is held by the second holder 26.

Another difference between the head 22 of FIGS. 15 and 16 and the head 22 of FIGS. 1-14 is the mechanism for opening the door 42. In the FIG. 6 embodiment, a push button 206 and spring 208 are held by the base holder 26 and allow for selective disengagement of the door 42 from the base holder 26.

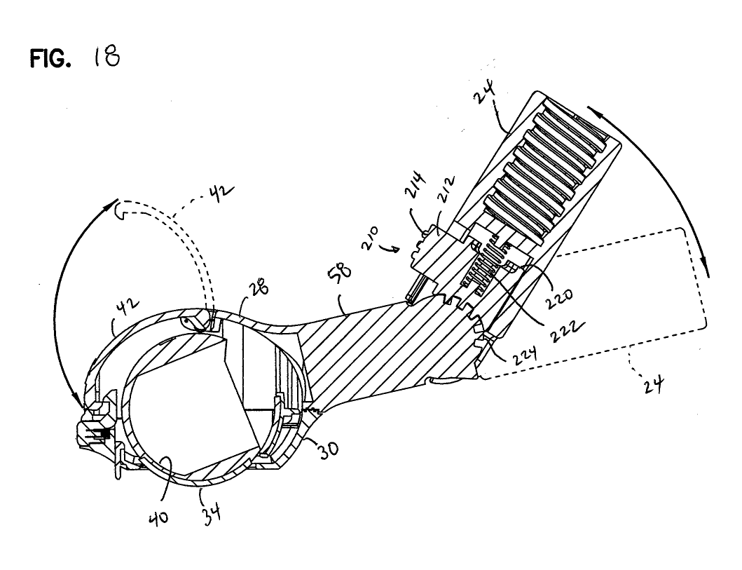

As with the previous embodiment, this embodiment also has the handle 24 pivotably connected to the post 58. In FIG. 18, a range of motion of the post 58 relative to the pivot axis 62 (FIG. 15) can be seen. This pivot angle can range from −10° to +60°, and will typically be about 0°-50°, often no greater than 47° and not less than 0°.

Attention is directed to FIGS. 18-20. In this embodiment, the post 58 and handle 24 include a geared tooth and slidable lock button arrangement 210. The arrangement 210 permits adjustably locking the pivot angle of the handle 24 relative to the base holder 26.

Many embodiments are possible. In this embodiment, a lock button 212 is held by the handle 24. The lock button 212 includes a finger-engaging surface 214, which is accessible external of the post 58 and allows for the user to manipulate the lock button 212. The lock button 212 also includes a head-engaging surface 216. The head-engaging surface 216 includes a first plurality of gear teeth 218.

Opposite of the head engaging surface 216 is a handle-engaging surface 220. A spring 222 is oriented between the handle engaging surface 220 and the handle 24. The spring 222 biases the lock button 212 in a direction toward the post 58.

In this embodiment, the post 58 includes a second plurality of gear teeth 224. The second plurality of gear teeth 224 removably mesh with the first plurality of gear teeth 218.

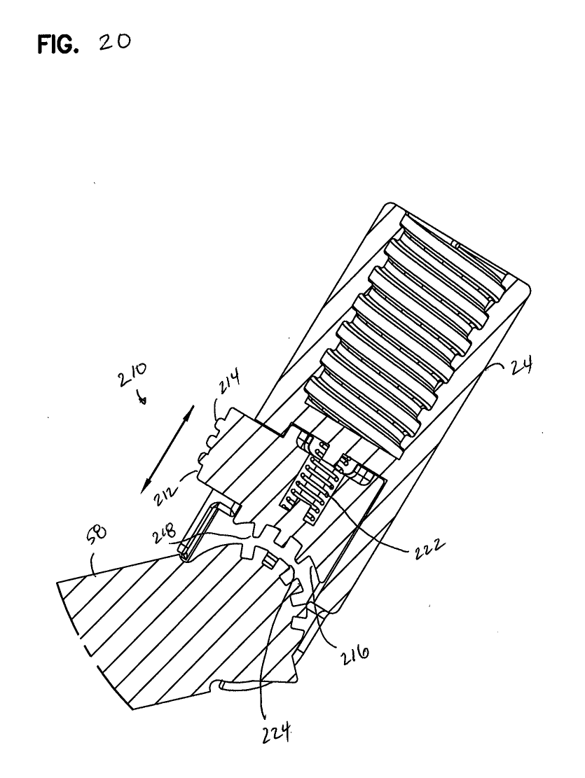

To adjust the pivot angle of the head 22 relative to the handle 24, the user places a finger, such as a thumb, against the hand-engaging surface 216 and slides the lock button 212 in a direction toward the handle 24 and against the spring 222. See FIG. 20. This moves the teeth 218, 224 out of engagement with each other. The head 222 is then free to pivot and can be moved to the desired angle. At the desired angle, the user releases the lock button 212, and the spring 222 moves the lock button 212 toward the post 58 so that the teeth 218, 224 mesh and lockably engage with each other. This will fix or hold the head 22 in the desired angled position relative to the handle 24.

It should be noted that the handle 24 in the embodiment of FIGS. 15-20 can be the same handle as described in the embodiment of FIGS. 1-14 and is preferably adjustable in length. It can also include a variety of ways to make the handle 24 adjustable, such as a threaded twist lock to allow the handle 24 to telescope between shorter and longer lengths.

A method of collecting fur using the embodiment of FIGS. 15-20 is similar to the method for the embodiment of FIGS. 1-14. In this method, the pivot angle of the base holder 26 relative to the handle 24 will typically be adjusted and locked into position. This is done by moving the lock button 212 against the spring 222 to release the meshing teeth 218, 224. The angle of the head 22 is then adjusted to the desired location, and the button 212 is released. This will then allow the teeth 218, 224 to engage, which will lock the head 22 in the desired angled position relative to the handle 24. After the pivot angle is adjusted, the fur attracting material 201, 202 of the roller 34 is rubbed over a surface to pick up hair from the surface.

The above represents principles of this disclosure. Many embodiments can be made using these principles.

What is claimed is:

1. A fur sweeper tool comprising:
(a) a base holder;
(b) a handle-engaging post extending from the base holder;
(c) roller rotatably held by the base holder having fur attracting material; and
(d) a handle pivotably connected to the post.

2. The fur sweeper tool of claim 1 wherein the handle has an adjustable length.

3. The fur sweeper tool of claim 1 wherein:
(a) the roller has a longitudinal axis which the roller rotates about; and
(b) the handle pivots about a pivot axis parallel to the longitudinal axis of the roller.

4. The fur sweeper tool of claim 3 wherein the handle pivots through a range of −10° to +60° relative to the pivot axis

5. The fur sweeper tool of claim 3 wherein the handle pivots through a range of −90° to +90° relative to the pivot axis.

6. The fur sweeper tool of claim 3 wherein the post and handle include a geared tooth and slidable lock button arrangement to permit adjustably locking the a pivot angle of the handle relative to the base holder.

7. The fur sweeper tool of claim 6 wherein:
(a) the lock button is held by the handle; is spring-biased toward the post; and has a first plurality of gear teeth; and
(b) the post includes a second plurality of gear teeth removably meshing with the first plurality of gear teeth.

8. The fur sweeper tool of claim 3 wherein the post and the handle include a protrusion—receiver arrangement constructed and arranged to permit pivoting of the handle relative to the base holder.

9. The fur sweeper tool of claim 1 wherein:
(a) the base holder includes an open tube; and
(b) the roller is held within the open tube.

10. The fur sweeper tool of claim 9 wherein the base holder has an opening providing exposure to the fur attracting material of the roller.

11. The fur sweeper tool of claim 1 wherein the roller defines a chamber to collect fur.

12. The fur sweeper tool of claim 11 wherein the chamber is accessible through a movable door secured to the base holder.

13. The fur sweeper tool of claim 12 wherein the door is transparent.

14. The fur sweeper tool of claim 12 wherein the door is selectively lockable and unlockable to the base holder.

15. The fur sweeper tool of claim 1 wherein the roller includes first and second twist knobs at opposite ends of the roller and extending outside of the base holder, the twist knobs allowing rotation of the roller within the base holder.

16. The fur sweeper tool of claim 15 wherein the roller is rotatable in a range between a first position at 0° to a second position greater than 90°.

17. The fur sweeper tool of claim 1 wherein the fur attracting material includes a non-adhesive fabric.

18. A method of collecting fur comprising:
(a) grasping a handle of a fur sweeper tool, the fur sweeper tool having a base holder, a post extending from the base holder connected to the handle, and a roller rotatably held by the base holder with fur attracting material; and
(b) adjusting a pivot angle of the base holder relative to the handle; and
(c) rubbing the fur attracting material of the roller over a surface to pick up hair from the surface.

19. The method of claim 18 further comprising a step of:
adjusting a length of the handle and then rotatably locking the length in place.

20. The method of claim 18 further including a step of:
rotating the roller by rotating one or more twist knobs secured thereto to at least partially clean hair from the fur attracting material of the roller.
